(19) United States
(12) Patent Application Publication
(10) Pub. No.: US 2025/0216244 A1
(43) Pub. Date: Jul. 3, 2025

(54) AUTOMATIC LOAD DETECTION FOR AN AGRICULTURAL MACHINE AND AGRICULTURAL HARVESTER

(71) Applicant: CNH Industrial Brasil Ltda., Nova Lima (BR)

(72) Inventors: JEAN CARLOS PEREIRA DE CAMARGO, Piracicaba (BR); DANIEL ROHRER PEREIRA, Piracicaba (BR); ALESSANDRO ROBERTO PEREIRA, Piracicaba (BR); MARCELO DOS SANTOS DE OLIVEIRA SILVA, Piracicaba (BR)

(21) Appl. No.: 18/987,534

(22) Filed: Dec. 19, 2024

(30) Foreign Application Priority Data
Dec. 28, 2023 (BR) 10 2023 027654 7

(51) Int. Cl. G01F 23/263; A01D 45/10; A01D 61/02; G01F 23/14; G01F 23/292; G01F 23/2962

(52) U.S. Cl. CPC G01F 23/263; A01D 45/10; A01D 61/02; G01F 23/14; G01F 23/2921; G01F 23/2962

(57) ABSTRACT

An automatic load detection system is applied to immediately identify and signal operators when a machine's work operations reach critical load levels, reducing operating risks and improving the machines' working conditions. In one aspect, the system includes a processing path formed by a conveyor roller assembly, a chopper assembly, and an elevator assembly of the machine. The system also includes at least one detector mechanism configured to identify the amount of harvested material in the processing path, wherein the at least one detector mechanism is configured to be installed in at least one location along said processing path and comprises an opening in which a movable plate is disposed, configured to move between a neutral position and an activated position, wherein said movable plate has a face facing the flow of harvested material, and an opposite face comprising a detector.

### FIELD OF INVENTION

The present invention relates, in general, to a new automatic load detection system to be applied to agricultural machinery, in particular, to those machines intended for harvesting tall and stalky plants, such as sugarcane. More specifically, this new automatic load detection system was designed to identify and signal to operators, or adopt operational adjustments, when the work operations of the agricultural machinery reach a critical load level, thereby reducing operating risks and improving the working conditions of the machines.

### BACKGROUND OF THE INVENTION

There are numerous models of agricultural equipment and machines in the state of the art that have been developed to increase productivity in the harvesting of different types of plant crops, for example, grain harvesters, forage harvesters and also harvesting machines for so-called tall and stalky plants, such as sugarcane.

Agricultural machinery designed for harvesting tall and stalky plants are designed and developed to enable the harvesting of this specific type of crop, because their intrinsic characteristics require specific conditions for their adequate processing, from cutting to transfer to transshipments and/or trailers.

In this context, it is known that these agricultural machinery for harvesting tall and stalky plants comprise a chassis that supports a series of conveyor and chopper rollers responsible for conveying and chopping the sugarcane into billets, which are transferred to the transshipments and/or trailers through an elevator assembly.

These agricultural machinery form a type of processing path that, in a way, starts at the front of the machine where the plants are agglutinated and cut, followed by the conveyor and chopper rollers assembly and, finally, transported and transferred to the transshipments and/or trailers via the elevator assembly. As those skilled in the art must appreciate, along this processing path there are specific points that, depending on the operating conditions, can receive, load and accumulate a varied volume of material and, consequently, operators need to monitor and manage the activities and work parameters, often based on the diagnostics and workloads along said path.

By way of example, the proximal end of the elevator assembly is a critical point that operators need to monitor, because depending on the operating conditions of the agricultural machine in the field, the load of harvested and chopped material that is dumped from the chopping rollers into the basket of the elevator assembly can be very large, exceeding certain limits that put activities in the field and the integrity of the machine at risk. More specifically, if the load of material is very high and no safety measures are adopted, the efficiency of the agricultural machine is at risk, but mainly it can lead to an overload of the machine's mechanisms, affecting productivity and increasing maintenance costs due to possible damage to the agricultural machine, and also it is necessary mention the risks to the safety of the operator.

This type of monitoring is usually done manually, requiring the operator to remain alert and, consequently, requiring skills and expertise from the operators. It is also worth noting that manually monitoring the operating load of the machines, and for example, the basket of the elevator assembly, is a complex and laborious task, diverting the attention of the operator who needs to remain alert to many other critical aspects required during the harvesting processes.

In this sense, it is clear that agricultural machinery designed for harvesting tall and stalky plants known in the state of the art reveal drawbacks and limitations involving the monitoring of the operating load at strategic points along the processing path, which can negatively interfere with the productivity, efficiency and yield of harvesting tasks in the field, and it is highly desirable to find practical solutions that enable this type of monitoring in order to avoid losses, damages and risks in operations carried out during harvests. Therefore, these are, among others, the problems, objectives and solutions that are intended to be overcome and achieved with the development of the present invention.

### DESCRIPTION OF THE INVENTION

Therefore, the present invention aims to provide a new proposal for an automatic load detection system to be applied to agricultural machinery, in particular, to those machines intended for harvesting tall and stalky plants, which was designed and developed to comprise technical, constructive and functional aspects to provide a practical and efficient solution to the drawbacks and limitations identified in the state of the art, as mentioned above.

More objectively, the present invention aims to provide a new load detection system to be installed in agricultural machinery which is configured to identify and signal to operators, or adopt measures to adjust operating parameters, when the work operations of the agricultural machine reach critical load levels that may eventually put work operations in the field at risk and, thus, increase the efficiency and productivity of agricultural harvesting machines.

Therefore, in order to achieve the technical and functional effects summarized above, among others, the present invention refers to a new automatic load detection system for agricultural machinery intended for harvesting tall and stalky plants, said automatic load detection system being formed, essentially, by a processing path consisting of a conveyor rollers assembly, a chopping assembly, an elevator assembly, and at least one detector mechanism configured to identify the amount of harvested material in the processing path, wherein the at least one detector mechanism is configured to be installed on at least one location along said processing path. Said detector mechanism, according to the present invention, comprises an opening in which is disposed a movable plate configured to move between a neutral position and an activated position, wherein said movable plate has a face facing the flow of harvested material, and an opposite face comprising a detector.

According to a particular embodiment of the system of the present invention, the at least one detector mechanism may be installed in the receiving basket of the elevator assembly. Optionally, this at least one detector mechanism may be installed in the storage housing of the elevator assembly.

In a possible embodiment of the present invention, said opening of the detector mechanism may be formed in the structure of the elevator assembly. Optionally, said detector mechanism may be installed in the receiving basket arranged at the region opposite the chopping assembly. Alternatively, said detector mechanism may be installed on the door of the storage housing of the elevator assembly.

Furthermore, according to another embodiment of the present invention, the automatic load detection system has a detector comprising a frame on which return elements are mounted, which may be springs, configured to provide support and movement of said mobile plate between the neutral and activated positions.

In some particular embodiments of the present invention said movable plate can be mounted in the opening of the detector mechanism by means of pivoting elements.

According to particular and possible embodiments of the present invention, said detector may comprise, for example, an assembly of load cells, an assembly of optical sensors, an assembly of pressure sensors, an assembly of ultrasonic sensors or, also, integrated capacitive sensors.

Additionally, according to other embodiments of the present invention, the automatic load detection system may be configured to provide operational adjustments of the agricultural machine associated with the amount of material harvested and the location of the amount of material harvested along said processing path. In particular embodiments, this operational adjustment may comprise managing the speed of the elevator based on the detection of an excessive amount of material harvested in the receiving basket of the elevator assembly or in the storage housing of the elevator assembly.

Furthermore, the present invention relates to a harvester, of the type for harvesting tall and stalky plants, for example for harvesting sugarcane, and which comprises a elevator assembly formed by an elevator housing within which an elevator extends between a lower proximal end provided with a receiving basket and an upper distal end, said agricultural harvester comprising an automatic load detection system as discussed above. According to particular embodiments of the present invention, said automatic load detection system may be installed in the receiving basket arranged at the lower proximal end of the elevator assembly, or alternatively, the automatic load detection system may be installed in a storage housing provided at the upper distal end of the elevator assembly.

### BRIEF DESCRIPTION OF THE DRAWINGS

The characteristics, advantages and technical effects of the present invention, as indicated above, will be more adequately understood by a person skilled in the art from the detailed description below, made by way of mere example, and not restrictive, of possible embodiments and with reference to the attached schematic drawings, which:

FIG. 1 is a schematic side view of an agricultural machine designed for harvesting tall, stalky vegetable crops, such as sugarcane;

FIG. 2 is a perspective view of the agricultural machinery elevator assembly with the automatic load detection system, according to an embodiment of the present invention;

FIG. 3 is a perspective view of the basket of the elevator assembly with the automatic load detection system, according to an embodiment of the present invention;

FIG. 4A is an enlarged schematic view of the detector mechanism of the automatic load detection system, according to an embodiment of the present invention, in a no-load condition;

FIG. 4B is an enlarged schematic view of the detector mechanism of the automatic load detection system, according to an embodiment of the present invention, in a loaded condition;

FIG. 5A is another enlarged schematic view of the detector mechanism of the automatic load detection system, according to an embodiment of the present invention, in the no-load condition;

FIG. 5B is an enlarged schematic view of the detector mechanism of the automatic load detection system, according to an embodiment of the present invention, in the loaded condition;

FIG. 6 is a perspective view of the distal end of the elevator assembly with the automatic load detection system, according to another embodiment of the present invention; and

FIG. 7 is an enlarged schematic view of the detector mechanism of the automatic load detection system, according to the embodiment of the present invention represented in FIG. 6.

### DESCRIPTION OF EMBODIMENTS OF THE INVENTION

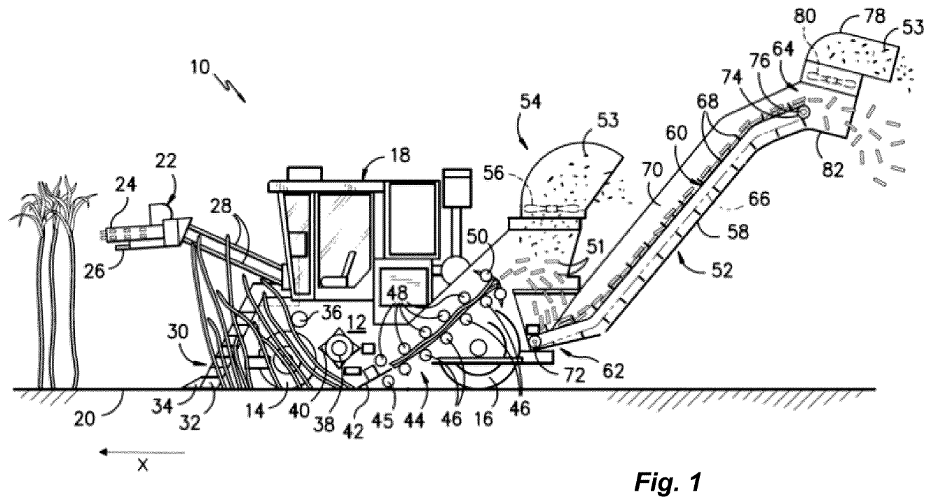

The invention will now be described with respect to its particular embodiments, with reference to the attached figures. Such figures are schematic, and their dimensions and/or proportions may not correspond to reality, as they aim to describe the invention in a didactic way. Furthermore, certain known and common construction details may have been omitted for greater clarity and conciseness in the description that follows. The reference numbers used are repeated throughout the figures to identify identical or similar parts. The terms eventually used such as “above”, “below”, “front”, “rear”, “right”, “left” etc. and its variants must be interpreted according to the guidance given in FIG. 1.

The terms used herein such as agricultural harvester, harvester, harvesting machine and their variants are used interchangeably to indicate an agricultural machine intended for harvesting a vegetable crop and, in the case of this description, for harvesting tall and stalky plants, such as sugarcane, energy cane, sweet sorghum, etc.

Turning now to the drawings, FIG. 1 illustrates a side view of one embodiment of an agricultural machine 10, such as an agricultural harvester according to aspects known in the prior art. As illustrated, the agricultural harvester 10 is configured as a sugarcane harvester. However, in other embodiments, the agricultural harvester 10 may correspond to any type of suitable harvester known in the state of the art.

Further referring to FIG. 1, the agricultural harvester 10 includes a chassis 12, a pair of front wheels 14, a pair of rear wheels 16, and an operator's cabin 18. The agricultural harvester 10 may also include a primary power source (e.g., a chassis-mounted engine 12) that powers one or both pairs of wheels 14, 16 via a transmission (not shown). Alternatively, the agricultural harvester 10 may be a track-driven combine and, therefore, it may include tracks driven by the drive mechanism in replacement of the illustrated wheels 14, 16. The drive mechanism may also drive a hydraulic fluid pump (not shown) configured to generate pressurized hydraulic fluid to drive various hydraulic components of the agricultural harvester 10, including the wheels or tracks.

Additionally, the agricultural harvester 10 comprises various components for cutting, processing, cleaning, and unloading sugarcane as the cane is harvested from an agricultural field 20. For example, the agricultural harvester 10 may include a tip cutter assembly 22 positioned on the its front end to intercept the sugarcane as the agricultural harvester 10 moves in the forward direction represented by the arrow X. As shown, the tip cutter assembly 22 may include both a gathering disc 24 and a cutting disc 26. The gathering disc 24 can be configured to gather sugarcane stalks so that the cutting disc 26 can be used to cut the tip of each stalk. Generally, the height of the tip cutter assembly 22 may be adjustable by means of a pair of arms 28 hydraulically raised and lowered as desired by the operator.

Additionally, the agricultural harvester 10 may include a row divider assembly 30 that extends upward and rearward from the field 20. In general, the row divider assembly 30 may include two spiral feed rollers 32, also known as a “lollipop”. Each feed roller 32 may include a soil shoe 34 as its lower end assists the row divider assembly 30 in separating sugarcane stalks for harvest. Furthermore, as shown in FIG. 1, the agricultural harvester 10 may include a knockdown roller 36 positioned near the front wheels 14 and a projection roller 38 positioned behind the knockdown roller 36. As the knockdown roller 36 is rotated, harvested sugarcane stalks are tipped while the row divider assembly 30 gathers the stalks from the crop field 20 into the machine 10. Additionally, as shown in FIG. 1, the projection roller 38 may include a plurality of intermittently mounted vanes 40 which assist in forcing the sugarcane stalks down. As the roller 38 is rotated during harvesting, the sugarcane stalks that were tipped by the knockdown roller 36 are separated and subsequently tipped by the roller 38 as the agricultural harvester 10 continues to be moved forward with respect to the field 20.

Still referring to FIG. 1, the agricultural harvester 10 may also include a base cutting assembly 42 positioned behind the roller 38. As is generally understood, the base cutting assembly 42 may include blades (not shown) for cutting the stalks of sugarcane as the cane is harvested. The blades, located on the periphery of the assembly 42, can be rotated by a hydraulic motor (not shown) driven by the hydraulic system of the machine. Additionally, in various embodiments, the blades may be angled downward to cut the base of the sugarcane as the cane is tipped over by the roller 38.

Additionally, the agricultural harvester 10 may include an assembly of one or more conveyor rollers 44 located downstream of the base cutting assembly 42 to move the cut stalks of sugarcane from the base cutting assembly 42 along the processing trajectory. As shown in FIG. 1, a lifting roller 45 is disposed between the base cutting assembly 42 and the conveyor roller assembly 44, wherein the lifting roller has the purpose of lifting the cut sugarcane from the ground 20 and convey it to the conveyor roller assembly 44 which is formed by a plurality of lower rollers 46 and a plurality of upper rollers 48. As the sugarcane is conveyed across the conveyor roller assembly 44, debris (e.g., rocks, dirt, and/or the like) may also be conveyed or fall through the lower rollers 46 onto the field 20.

Additionally, the agricultural harvester 10 may include a chopper assembly 50 located at the downstream end of the conveyor roller assembly 44 (e.g., adjacent to the rearmost lower and upper conveyor rollers 46, 48). In general, the chopper assembly 50 may be used to cut or chop harvested sugarcane stalks into smaller pieces or “fragments” 51 that may, for example, measure 15.24 centimeters (six (6) inches), also called billets or stalk sections. The fragments 51 can then be propelled towards an elevator assembly 52 of the agricultural harvester 10 to be collected in an external receiver or storage device (not shown), such as a transshipment or trailer.

As is generally understood, pieces of waste 53 (e.g., dust, dirt, leaves, etc.) separated from the sugarcane fragments 51 may be expelled from the agricultural harvester 10 through a primary extractor 54, which is located behind the chopper assembly 50 and is oriented to direct waste 53 out of the harvester 10. Additionally, a fan 56 may be mounted on the primary extractor 54 to generate a suction force or vacuum sufficient to capture the waste 53 and forcing these waste 53 through the primary extractor 54. The waste 53 are then directed outward and, generally in the opposite direction of the agricultural harvester 10 through an outlet of the primary extractor 54. The separated fragments 51 and those heavier than the waste 53 that is being expelled from the extractor 54 can then fall onto the elevator assembly 52.

According to this specification, the elevator assembly 52 must be understood as generally comprising, an elevator housing structure 58 and an elevator 60 extending within said elevator housing structure 58 between a lower proximal end 62 and an upper distal end 64. The lower proximal end 62 being fixed to the machine 10 and the upper distal end 64 having an opening 82 for discharging the harvested material.

In additional or alternative embodiments, the elevator 60 may include a chain or conveyor belt 66 and a plurality of paddles or flights 68 coupled to or evenly spaced on the chain 66. The flights 68 may be configured to hold the sugarcane fragments 51 on the elevator 60 as the fragments 51 are raised to the upper portion 70 of the elevator 60. Additionally, the elevator 60 may include lower and upper sprockets 72, 74 positioned around the proximal and distal ends 62, 64, respectively. As shown in FIG. 1, an elevator engine 76 may be coupled to one of the sprockets (e.g., the upper sprocket 74) to drive the chain 66, thereby allowing the chain 66 and flights 68 to travel in an endless cycle between the proximal and distal ends 62, 64 of the elevator 60.

Furthermore, pieces of waste 53 (e.g., dust, dirt, leaves, etc.) separated from the sugarcane fragments 51 may be expelled from the agricultural harvester 10 through a secondary extractor 78 coupled to the rear end of the elevator housing structure 58. As shown in FIG. 1, the secondary extractor 78 may be disposed adjacent to the distal end 64 of the elevator 60 and may be oriented to direct waste 53 outward from the harvester 10. Additionally, a fan 80 may be mounted on the secondary extractor 78 to generate a suction force or vacuum sufficient to extract the waste 53 and force such waste 53 through the secondary extractor 78. The separated, heavier fragments 51 than the waste 53 expelled through the extractor 78 may then fall from the distal end 64 of the elevator 60. Typically, fragments 51 may be cast away or thrown out a discharge opening 82 of the elevator assembly 52 into an external storage device, such as a car, a transshipment, a dumpster, a trailer, etc.

During operation, the agricultural harvester 10 travels across the entire agricultural field 20 to harvest sugarcane or any other tall and stalky plant. After the height of the tip cutter assembly 22 is set (if used) by means of the arms 28, the gathering disc 24 in the tip cutter assembly 22 can be operated to gather the sugarcane tips as the agricultural harvester 10 advances through the field 20, while the cutting disc 26 cuts the leafy ends of the sugarcane stalks to dump them along both sides of the harvester 10. As the stalks enter the row divider assembly 30, the shoes 34 can configure the width of the operation to determine the amount of sugarcane that enters the throat of the agricultural harvester 10, either in a fixed or adjustable way. The lollipops 32 then agglutinate the stalks at the machine inlet to allow the knockdown roller 36 to bend the stalks downward in conjunction with the action of the roller with fins 38. Since the stalks are positioned at an angle as shown in FIG. 1, the base cutting assembly 42 can then cut the base of the field stalks 20. The cut stalks are then lifted by the lifting roller 45 and directed to the conveyor roller assembly 44.

The cut stalks of sugarcane are transported backwards by conveyor rollers 46, 48 which compress the stalks and harvested material. At the downstream end of the conveyor roller assembly 44, the chopper assembly 50 cuts or chops the compacted sugarcane stalks into pieces or fragments 51. Conveyed waste 53 (e.g., dust, dirt, leaves, etc.) separated from the sugarcane fragments 51 are then extracted through the primary extractor 54 using the suction created by the fan 56. The separated/cleaned fragments 51 then fall to the elevator assembly 52 and travel upward through the elevator 60 from its proximal end 62 to its distal end 64. During normal operation, once the fragments 51 reach the distal end 64 of the elevator 60, the fragments 51 are thrown out the discharge opening 82 up to an external storage device. Similar to the primary extractor 54, waste is blown out of the agricultural harvester 10 through the secondary extractor 78 with the aid of the fan 80.

An agricultural machine 10, as described above, may be, for example, a machine known in the state of the art, such as the sugarcane harvesters from CNH Industrial N.V. sold under the Case IH brand.

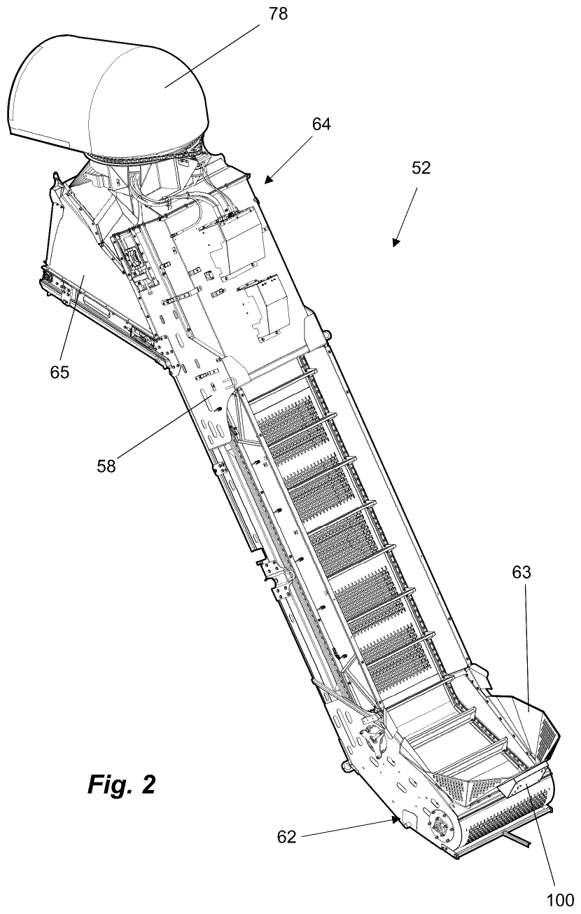

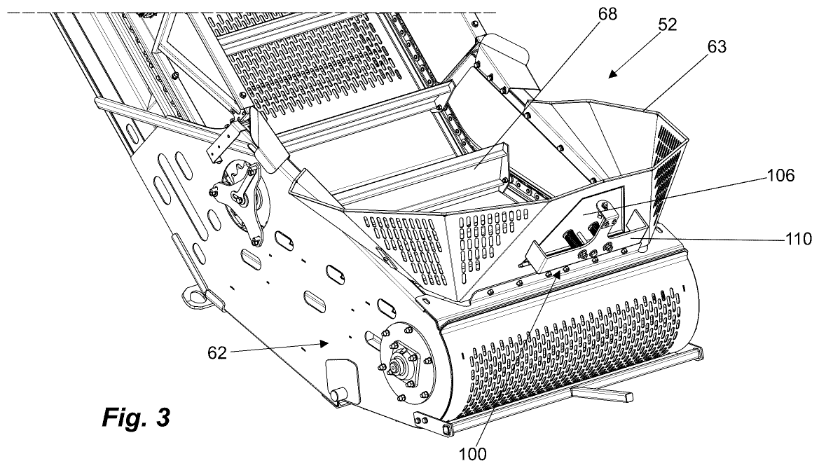

With particular reference to FIG. 2, it is possible to observe a model of an elevator assembly 52 that typically comprises an elevator housing structure 58 and an elevator 60 that extends within said elevator housing structure 58 between a lower proximal end 62 provided with a basket 63 configured to receive the sugarcane billets that are cut by the chopper assembly 50, and an upper distal end 64 that, in this configuration, comprises a storage housing 65 configured to control and manage the discharge of material into the transshipments and/or trailers through the discharge opening 82.

Now, as represented in the other figures, the present invention deals with a new automatic load detection system 100 configured to indicate to operators, or adjust the operational parameters of the machines, when the work operations of the agricultural machine reach a critical load level. To this end, this new automatic load detection system 100 designed particularly to be installed in agricultural machinery 10 intended for harvesting tall and stalky plants, is formed by at least one detector mechanism 102 configured to immediately identify the amount of harvested material in the processing path, and the at least one detector mechanism 102 is configured to be installed in at least one location along the processing path that corresponds to the section of the elevator assembly 52 where it is likely to provide accumulation of material, for example, in the receiving basket 63 or in the storage housing 65.

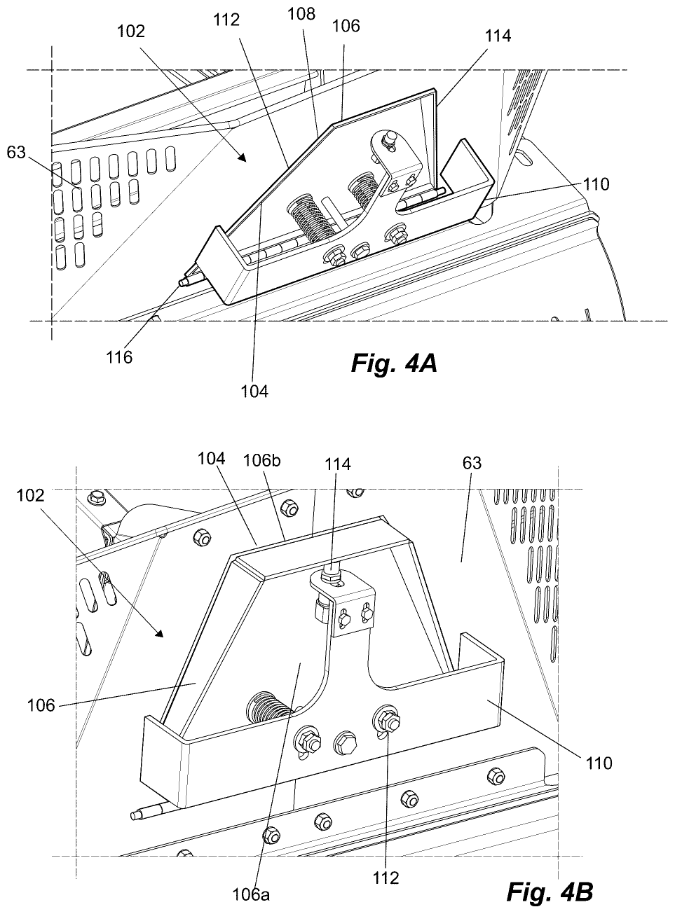

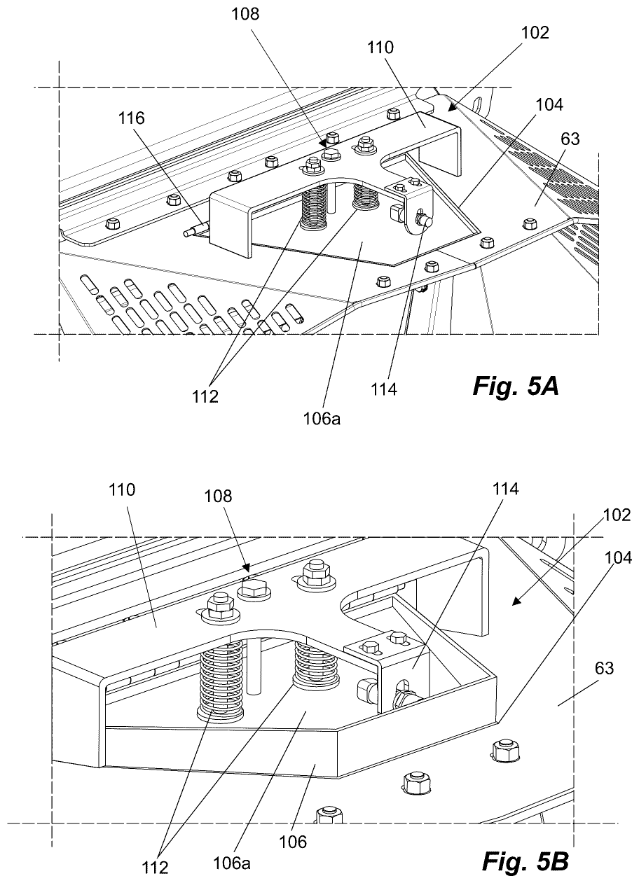

According to a particular embodiment of the present invention, the automatic load detection system 100 comprises a detector mechanism 102 that may be obtained by an opening 104 formed in the structure of the elevator assembly 52, which is closed by a movable plate 106 configured to move between a neutral position and an activated position, as represented, respectively, in FIGS. 4A/5A and 4B/5B. Said movable plate 106 is mounted at the opening 104 so that one face 106a is directed towards the flow of harvested material, while the opposite face 106b comprises a detector 108.

According to one embodiment, said detector 108 may be formed by a frame 110 on which are mounted return elements 112 configured to provide for the displacement of said movable plate between the neutral and activated positions.

Additionally, said frame 110 has a sensor 114 configured for immediate identification of operators and/or adoption of measures for operational adjustments, when activated, and said sensor 114 is configured to be activated when said mobile plate 106 moves to the activated position, promoting contact between the sensor 114 and the mobile plate 106.

According to particular embodiments of the present invention, said mobile plate 106 is mounted at the opening 104 by means of pivoting elements 116, so that, depending on the quantity of material processed and accumulated in the elevator assembly 52, said mobile plate 106 is pivoted with the aid of the return elements 112.

Said return elements 112 may be, according to particular embodiments of the present invention, helical springs mounted so that the resting state is in the condition of pushing said movable plate 106 in the direction of the flow of processed material. Optionally, said return elements may be other types of springs or any components configured to allow the support and, at the same time, the displacement of said movable plate 106 with respect to said opening 104.

According to a particular embodiment of the present invention the detector mechanism 102 can be installed in the receiving basket 63 arranged at the proximal end 62 of the elevator assembly 52 and, more particularly, positioned at the region opposite the chopping assembly 50.

Alternatively, according to another possible embodiment of the automatic load detection system 100, object of the present invention, said detector mechanism 102 can be mounted in the storage housing 65, in the agricultural machine models 10 whose the elevator assembly 52 has this type of accessory for managing the unloading of material.

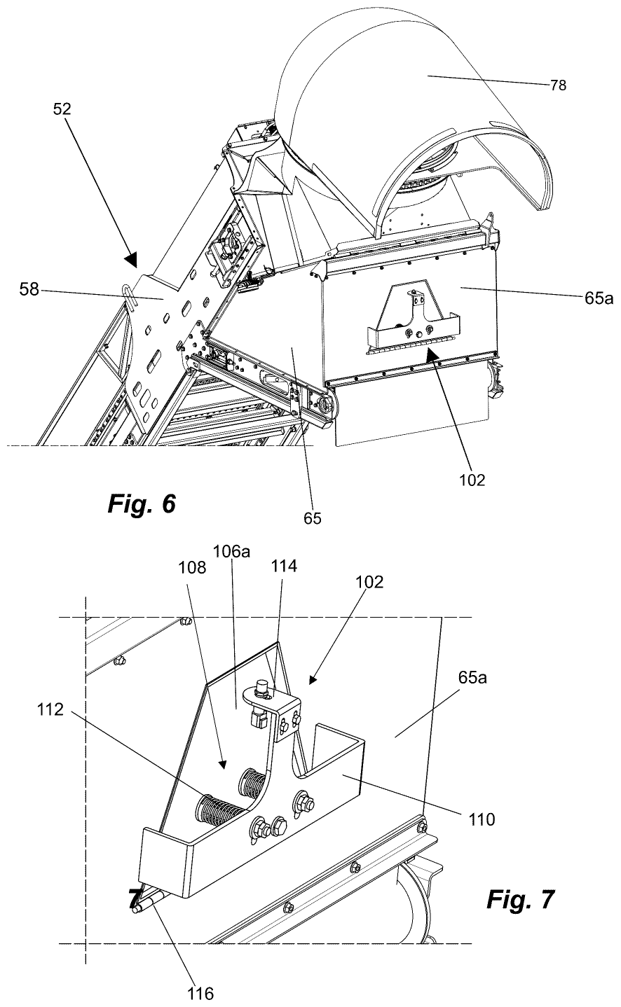

According to the embodiment represented in FIGS. 6 and 7, said detector mechanism 102 can be mounted on the door 65a of the storage housing 65 and, in this way, said opening 104 and the movable plate 106 are arranged at the region opposite to the discharge of the elevator 60.

Therefore, as should be appreciated by those skilled in the art, and according to the embodiments represented in the attached figures, the automatic load detection system 100, according to the present invention, can be activated based on the weight exerted by the sugarcane that is accumulated in the receiving basket 63 or in the storage housing 65, so that the return elements 112, strategically positioned, contract, moving the mobile plate 106 in relation to the opening 104 when the accumulation of sugarcane reaches a predetermined level. At this moment, when the mobile plate 106 moves, contact occurs with the sensor 114, which immediately notifies the operator of the agricultural machine 10, or adopts operational adjustment measures, so that preventive measures are adopted in order to avoid problems of overload and loss of material.

Optionally, according to particular embodiments of the present invention, the detector 108 may also be formed by an assembly of load cells, which could be installed in strategic locations within the receiving basket 63 or within the storage housing 65, with said load cells being configured to monitor the weight exerted by the sugarcane billets 51 accumulated in the receiving basket 63 and, at the moment in which a limit weight is reached, identifying the maximum working capacity, the assembly of load cells automatically send signals to notify the operator and/or to adopt measures for operational adjustments of the machine.

In another possible embodiment of the automatic load detection system 100, according to the present invention, said detector 108 may be comprised of an assembly of optical sensors, which may be installed at different heights within the receiving basket 63 or the storage housing 65, in order to detect the level of accumulated sugarcane billets 51 and, if a certain level of billets 51 is reached, the optical signals are, in a certain way, obstructed by the sugarcane, indicating the maximum work load and, with this, the assembly of optical sensors may notify the operator and/or adopt operational adjustment measures.

Moreover, optionally, in another embodiment of the present invention, the automatic load detection system may comprise a detector 108 formed by an assembly of pressure sensors, which are installed inside the receiving basket 63 or the storage housing 65 of the elevator assembly 52, and are configured to measure the pressure exerted by the sugarcane billets 51 that accumulate in the receiving basket 63 or in the storage housing 65, at the moment in which a certain pressure limit value is reached, indicating that the receiving basket 63 or the storage housing 65 is full, the pressure sensors may send signals for immediate notification of the operator and/or for the adoption of operational adjustment measures of the machines.

Additionally, in another possible embodiment of the automatic load detection system of the present invention, said detector 108 is an assembly of ultrasonic sensors, which are configured to identify the level of sugarcane billets 51 accumulated in the receiving basket 63 or in the storage housing 65. Thus, the ultrasonic sensors can emit sound waves to measure the time it takes for the waves to bounce off the surface of the sugarcane. At the moment the receiving basket 63 or the storage housing 65 is full, the distance measured by the ultrasonic sensors indicates a specific value, determining whether it is full and, with this, a signal is automatically sent for immediate notification of the operator and/or adoption of measures to provide operational adjustment of the machine.

Operational adjustment of the machine may be, for example, to change the speed of the elevator 60 depending on the amount of material harvested and the location of the amount of harvested material along the material processing path. For example, if a large amount of harvested material is detected in the receiving basket 63 of the elevator assembly 52, the speed of the elevator 60 may be increased so that the harvested material is distributed along the elevator housing 58. Conversely, if an excessive amount of material is detected at the upper distal end 64 of the elevator assembly 52, the speed of the elevator 60 may be decreased or the elevator may be stopped so that more harvested material accumulates in the receiving basket 63 of the elevator assembly 52.

And, according to another possible embodiment of the detector 108 of the automatic load detection system, according to the present invention, integrated capacitive sensors are used, which are installed in the receiving basket 63 and/or in the storage housing 65, and are configured so that, as the sugarcane billets 51 fill the receiving basket 63 or the storage housing 65, the capacitance between the sensors and the sugarcane ends up changing. When the capacitance reaches a predetermined limit, indicating fullness of operating load, the capacitive sensors can automatically send a signal for immediate notification of the operator and/or signals to provide operational adjustment of the machine.

Consequently, as can be seen, this new automatic load detection system, which is the object of the present invention, is capable of providing effects and advantages directly related to the functional aspects of agricultural machinery 10, efficiently and safely managing and monitoring operational loads during harvesting activities in order to eliminate the risk of overload, especially in the elevator assembly, ensuring and increasing productivity in the field.

Additionally, significant advantages can be observed for operators, who do not need to monitor the level of loads being processed by the machine, given that, now, with the system of the present invention, it becomes possible to ensure that the agricultural machinery perform its operations and, if a load level above a predefined limit is detected, operators can be notified immediately so that appropriate measures can be taken to manage the machine's activities in the field.

Therefore, it is noted that the present invention provides an efficient solution to the problems usually observed in the state of the art and, with this, making it possible to improve the operating conditions of the machines in the field, but mainly to eliminate losses and problems with the machine due to it working in a condition above normal.

The present invention also relates to a agricultural harvester, such as an agricultural machine 10 intended for harvesting tall and stalky plants, which comprises an elevator assembly 52 formed by an elevator housing 58 and an elevator 60 that extends within the elevator housing 58 between a lower proximal end 62 provided with a receiving basket 63 and a distal end 64, said agricultural machine 10 comprising an automatic load detection system 100, as described and defined above, which is installed in a strategic location along the processing path and, more particularly, in the section formed by the elevator assembly 52.

According to an embodiment of the present invention, said automatic load detection system can be installed particularly in the receiving basket 63 arranged at the proximal end of the elevator assembly 52.

According to a particular embodiment of the present invention, said agricultural machine 10 further comprises a storage housing 65 arranged at the distal end of the elevator assembly 52, configured to manage and control the unloading of material and, in this case, said automatic load detection system can be installed in said storage housing 65.

According to possible embodiments of the present invention, this agricultural machine 10 is designed and developed to carry out sugarcane harvesting.

Finally, considering all of the above, it is important to highlight that the present description aims only to present and define, by way of example, particular embodiments of the new automatic load detection system applied to agricultural machinery 10 that are intended for harvesting tall and stalky plants, as defined by the present invention. Therefore, as those skilled in the art should appreciate, various modifications and combinations of equivalent elements and details are possible without, however, departing from the scope of protection defined by the attached claims.

1-20. (canceled)

21. An automatic load detection system for an agricultural machine, the system comprising:
a processing path formed by a conveyor roller assembly, a chopping assembly (50), and an elevator assembly of the agricultural machine; and
at least one detector mechanism configured to identify an amount of harvested material in the processing path, the at least one detector mechanism configured to be installed in at least one location along the processing path,
wherein the at least one detector mechanism comprises an opening in which a movable plate is arranged and configured to move between a neutral position and an activated position, wherein the movable plate has a face facing a flow of the harvested material, and an opposite face comprising a detector.

22. The system according to claim 21, wherein the at least one detector mechanism is installed in a receiving basket of the elevator assembly.

23. The system according to claim 23, wherein the receiving basket of the elevator assembly is arranged at a region opposite the chopping assembly.

24. The system according to claim 21, wherein the at least one detector mechanism is installed in a storage housing of the elevator assembly.

25. The system according to claim 22, wherein the at least one detector mechanism is installed on a door of the storage housing of the elevator assembly.

26. The system according to claim 21, wherein said opening is defined in a structure of the elevator assembly.

27. The system according to claim 21, wherein the detector mechanism comprises a frame in which return elements are mounted, the frame being configured to provide support movement of the movable plate between said neutral and activated positions.

28. The system according to claim 27, wherein said return elements comprise coil springs.

29. The system according to claim 21, wherein the movable plate is mounted at said opening through pivoting elements.

30. The system according to claim 21, wherein the detector comprises an assembly of load cells.

31. The system according to claim 21, wherein the detector comprises an assembly of optical sensors.

32. The system according to claim 21, wherein the detector comprises an assembly of pressure sensors.

33. The system according to claim 21, wherein the detector comprises an assembly of ultrasonic sensors.

34. The system according to claim 21, wherein the detector comprises integrated capacitive sensors.

35. The system according to claim 21, wherein data provided by the at least one detector mechanism allows the system to provide operational adjustments of the agricultural machine associated with the amount of material harvested and a location of the amount of material harvested along the processing path.

36. The system according to claim 35, wherein the operational adjustment comprises management of a speed of an elevator of the elevator assembly based on a detection of an excessive amount of material collected in a receiving basket or in a storage housing of the elevator assembly.

37. An agricultural harvester comprising the system as defined in claim 21, the elevator assembly being formed by an elevator housing within which an elevator extends between a lower proximal end provided with a receiving basket and an upper distal end.

38. The agricultural harvester according to claim 37, wherein the at least one detector mechanism in installed in the receiving basket and is arranged at the lower proximal end of the elevator assembly.

39. The agricultural harvester according to claim 37, wherein the at least one detector mechanism in installed in a storage housing arranged at the upper distal end of the elevator assembly.

40. The agricultural harvester according to claim 37, wherein the agricultural harvester comprises a sugarcane harvester.
